(19) United States
(12) Patent Application Publication
(10) Pub. No.: US 2024/0132388 A1
(43) Pub. Date: Apr. 25, 2024

(54) METHOD FOR REMOVING POLYVINYLPYRROLIDONE FROM WATER USING SALTS AND USING THE REMOVED COMPOSITION FOR FURTHER WATER TREATMENT

(71) Applicant: Neo Chemicals & Oxides, LLC, Greenwood Village, CO (US)

(72) Inventors: Mason Reames HANELINE, Orange, CA (US); Yong YAN, Singapore (SG)

(73) Assignee: Neo Chemicals & Oxides, LLC, Greenwood Village, CO (US)

(21) Appl. No.: 18/485,046

(22) Filed: Oct. 11, 2023

Related U.S. Application Data
(60) Provisional application No. 63/415,164, filed on Oct. 11, 2022.

(51) Int. Cl. C02F 9/00; B01J 20/26; C02F 1/28

(52) U.S. Cl. CPC C02F 9/00; B01J 20/265; C02F 1/285; C02F 2101/38

(57) ABSTRACT

A method for removing polyvinylpyrrolidone (PVP) from water using rare earth salts, iron salts, or mixtures thereof effectively and efficiently removes undesired and dissolved PVP and provides a composition containing hydrolyzed PVP (h-PVP) having ions bound thereto. In these compositions the ions include rare earth cations, iron cations, and mixtures thereof. This composition is beneficial in the removal of aqueous contaminants, such as phosphate, other phosphorus containing compounds, arsenic, arsenic containing compounds, fluorides, and PFAS from water.

### RELATED APPLICATIONS

This application claims priority to U.S. Provisional Application Ser. No. 63/415,164 filed Oct. 11, 2022, the complete disclosure of which is incorporated herein by reference in its entirety.

### FIELD OF THE INVENTION

This disclosure relates to a method of removing polyvinylpyrrolidone from water using rare earth salts, iron salts, or mixtures thereof. This disclosure further relates to the composition formed from this removal and then to methods for using this composition as a soil amendment or filter for water treatment and, particularly for treating water to remove phosphorus, arsenic, fluoride, or PFAS contaminants.

### INTRODUCTION

Anthropogenic contaminants in water are becoming a greater concern worldwide. Thus, methods for removing contaminants continue to be needed, particularly for difficult to remove contaminants. One such contaminant is polyvinylpyrrolidone (PVP) in all of its variations. PVP is commonly called polyvidone or povidone. The defining structure is a polyethylene backbone with γ-lactam units appended to every other carbon on the backbone by a carbon-nitrogen bond. It can be produced in a variety of molecular weights. PVP was invented circa 1939 and was initially used as a blood plasma substitute but is now used in many applications and products, including membranes, emulsifiers, glue sticks, batteries, ceramics, fiberglass, inks, tooth whitening gels, personal care products and surfactants to name a few. Although PVP is generally recognized as safe (GRAS), there is growing concern related to the environmental impact of high molecular weight substances such as PVP. Part of the concern rises from PVP bioaccumulating and being very resistant to biodegradation and oxidation.

Reaction of PVP with ozone or peroxides does not degrade the polymer but rather converts the γ-lactam to a succinimide. Thus, removal of PVP from water appears to be challenging. It is highly soluble in polar solvents like water and thus difficult to precipitate. Degradation in a traditional aeration basis has been reported to be ineffective. Filtration methods such as reverse osmosis (RO) or nanofiltration should work in theory but suffer from challenges such as clogging, high financial costs, and disposal of the rejected water. Sorption methods show promise but are impractical at high concentrations and disposal of the sorption media can be an issue. Specific microorganisms have been reported but tending to specific microorganisms can also be challenging. In summary, PVP is difficult to remove, and traditional methods seem ineffective.

There remains a need in the art for an effective method for removing PVP from water sources.

### SUMMARY

This disclosure relates to a method for removing PVP from water. The disclosure further relates to a composition for treating water comprising hydrolyzed PVP (h-PVP) and cations, wherein the cations are bound to the h-PVP. In this PVP composition, the cations are selected from rare earth cations, iron cations, or mixtures thereof. These compositions can be used as adsorption media for water treatment, particularly for treating water to remove phosphorus, arsenic, fluoride, or PFAS contaminants. As such, these compositions can be included within a soil amendment or a filter.

The present disclosure includes a method for removing undesired and dissolved PVP from water that combines the hydrolysis of PVP with the addition of a rare earth salt, iron salt or mixture thereof. This method provides for the removal of the PVP by standard solid-liquid separation techniques such as settling and filtration. The precipitated solid (i.e., h-PVP with rare earth and/or iron cations bound) then can be used as an adsorption media to remove contaminants, including phosphate, from water. As such, the present disclosure addresses the need for removing PVP from water and also creates a use for an otherwise waste product.

Disclosed herein is a method for removing polyvinylpyrrolidone (PVP) from an aqueous stream. This method comprises (i) providing an aqueous stream having a first PVP concentration; (ii) hydrolyzing the aqueous stream to provide an aqueous stream containing h-PVP; (iii) contacting the aqueous stream containing h-PVP with a rare earth salt, iron salt, or mixture thereof to precipitate h-PVP with cations bound to the h-PVP; and (iv) providing a treated aqueous stream with a PVP concentration less than the first PVP concentration. In certain embodiments the salt is a rare earth salt and the cations bound to the h-PVP are rare earth cations. In other embodiments the salt is a mixture of a rare earth salt and an iron salt.

Also disclosed herein is the h-PVP composition for treating water. This h-PVP composition may be incorporated into a soil amendment or a filter. This composition comprises hydrolyzed PVP (h-PVP) and ions bound to the h-PVP. As such, the composition for treating water comprises (a) h-PVP and (b) rare earth cations, iron cations, or mixtures thereof, wherein the cations are bound to the h-PVP and wherein the composition comprises about 1% to about 50% by weight cations based on the total weight of the composition not taking into account any water present in the composition. In certain embodiments, the composition comprises about 1% to about 40% by weight cations based on the total weight of the composition not taking into account any water present in the composition. In specific embodiments, the cations are rare earth cations. In some of these embodiments, the h-PVP is about 20% to about 75% hydrolyzed.

Also as disclosed herein is a method for removing contaminants from an aqueous stream using the composition comprising h-PVP and ions bound to the h-PVP. This method for removing contaminants from an aqueous stream, comprises: (i) contacting an aqueous stream having a first contaminant concentration with a composition for treating water comprising (a) h-PVP and (b) rare earth cations, iron cations, or mixtures thereof, wherein the cations are bound to the h-PVP and wherein the composition comprises about 1% to about 50% by weight cations based on the total weight of the composition not taking into account any water present in the composition; (ii) removing contaminants from the aqueous stream by contact of the aqueous stream with the composition; and (iii) providing a treated aqueous stream with a second contaminant concentration less than the first contaminant concentration, wherein the contaminant is selected from the group consisting of phosphate, phosphorus containing compounds, arsenic, arsenic containing compounds, PFAS, fluorides, and mixtures thereof. In certain embodiments the cations are rare earth cations. In other embodiments the cations are a mixture of rare earth cations and iron cations. In certain embodiments, the second contaminant concentration is about 50% to about 90% less than the first contaminant concentration.

This method may further include a step of setting a target contaminant concentration and monitoring the second contaminant concentration to ensure that it is at or less than the target concentration. With these additional steps, the method may further comprise comparing the second contaminant concentration to the target concentration and replacing the composition for treating water when the second contaminant concentration in the treated aqueous stream exceeds the target concentration. The method may further comprise monitoring the second contaminant concentration and replacing the composition for treating water when the second contaminant concentration in the treated aqueous stream begins to increase.

Further disclosed are integrated methods for removing PVP from an industrial aqueous stream and recycling the removed PVP to remove contaminants from water. This integrated method comprises the steps of: (i) providing an industrial aqueous stream having a first PVP concentration; (ii) hydrolyzing the industrial aqueous stream to provide an aqueous stream containing h-PVP; (iii) contacting the aqueous stream containing h-PVP with a rare earth salt, iron salt, or mixture thereof to precipitate h-PVP with rare earth cations, iron cations, or mixtures thereof bound to the h-PVP; and (iv) isolating the precipitated h-PVP with cations bound. In certain embodiments the salt and resulting cations are rare earth or mixtures of rare earth and iron.

This precipitated h-PVP with cations bound is then used to treat water containing contaminants. This part of the integrated method comprises (v) contacting a water stream having a first contaminant concentration with the precipitated h-PVP with cations bound to the h-PVP and removing contaminants from the water stream; and (vi) providing a treated stream with a second contaminant concentration less than the first contaminant concentration. In this integrated method the contaminant is selected from the group consisting of phosphate, phosphorus containing compounds, arsenic, arsenic containing compounds, PFAS, fluorides, and mixtures thereof.

This integrated method may further include a step of setting a target contaminant concentration or target PVP concentration and monitoring to ensure that these are at or less than the target concentration. With these additional steps, the method may further comprise comparing the second contaminant and/or PVP concentration to the target concentrations. With regard to the second contaminant concentration, the method may further include replacing or refreshing the h-PVP composition for treating water when the second contaminant concentration in the treated water stream exceeds the target concentration. As such, the method may further comprise monitoring the second contaminant concentration and replacing/refreshing the h-PVP composition for treating water when the second contaminant concentration in the treated aqueous stream begins to increase.

### BRIEF DESCRIPTION OF THE DRAWINGS

FIG. 1 is a general flow diagram for removal of PVP from water by hydrolysis and then rare earth addition.

FIG. 2 is a general flow diagram for removal of contaminants using the hydrolyzed PVP (h-PVP) composition with cations bound thereto.

FIG. 3 is a plot of the phosphate removal capacity of the hydrolyzed composition.

### DETAILED DESCRIPTION

Before the methods and compositions for treating water are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “an amendment composition or a PVP composition” is not to be taken as quantitatively or source limiting, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, weight percent, concentration range, time frame, molecular weight, temperature, or pH. Such a range can be within an order of magnitude, typically within 10%, and even more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

The present application relates to a method of removing polyvinylpyrrolidone (PVP) from water sources. It was recognized that one process that may aid PVP removal is alkaline hydrolysis. Under alkaline conditions the γ-lactam ring can open which converts it into a γ-Aminobutyric acid. This hydrolysis can be aided by first oxidizing the γ-lactam to a succinimide, as the succinimide is more easily hydrolyzed. The hydrolyzed PVP polymer (completely hydrolyzed it could be called a polyvinyl aminobutyrate) does not show increased biodegradability. Thus, PVP can be changed chemically, but this change does not appear to aid in its removal alone. It was surprisingly discovered that removal could be aided by using rare earth salts, iron salts, or mixtures thereof.

As such, the present application relates to a method of removing PVP from water sources using rare earth salts, iron salts, or mixtures thereof. The present application further relates to the PVP composition formed by this process, wherein the composition comprises (a) hydrolyzed polyvinylpyrrolidone (h-PVP) and (b) rare earth cations, iron cations, or mixtures thereof, wherein the cations are bound to the h-PVP and wherein the composition comprises about 1% to about 50% by weight cations based on the total weight of the composition not taking into account any water present in the composition. This PVP composition then may be used for treating water sources to remove contaminants selected from the group consisting of phosphate, phosphorus containing compounds, arsenic, arsenic containing compounds, PFAS, fluorides, and mixtures thereof.

As such, the present application additionally relates to integrated methods for treating water wherein initially a water source, such as industrial waste-water, is treated to remove PVP and this treatment creates a composition comprising (a) hydrolyzed polyvinylpyrrolidone (h-PVP) and (b) rare earth cations, iron cations, or mixtures thereof, wherein the cations are bound to the h-PVP and wherein the composition comprises about 1% to about 50% by weight cations based on the total weight of the composition not taking into account any water present in the composition. In certain embodiments, the cations are rare earth cations. In other embodiments, the cations are a mixture of rare earth cations and iron cations. This PVP composition is then utilized in methods for removing contaminants from an aqueous stream, wherein the contaminants are selected from the group consisting of phosphate, phosphorus containing compounds, arsenic, arsenic containing compounds, PFAS, fluorides, and mixtures thereof.

### Method of Removing PVP from Water

In its first embodiment, the present application relates to effective and efficient methods for removing PVP from an aqueous stream. This method uses rare earth cations, iron cations, or mixtures thereof. This method forms a composition comprising (a) hydrolyzed polyvinylpyrrolidone (h-PVP) and (b) cations, wherein the cations are bound to the h-PVP and wherein the composition comprises about 1% to about 50% by weight cations based on the total weight of the composition not taking into account any water present in the composition. The cations are rare earth cations, iron cations, or mixtures thereof.

In certain embodiments, the cations are rare earth cations and the composition formed comprises (a) hydrolyzed polyvinylpyrrolidone (h-PVP) and (b) rare earth cations, wherein the rare earth cations are bound to the h-PVP and wherein the composition comprises about 1% to about 50% by weight rare earth cations based on the total weight of the composition not taking into account any water present in the composition. In certain embodiments, the composition comprises about 10% to about 40% by weight cations based on the total weight of the composition not taking into account any water present in the composition.

In other embodiments, the cations are iron cations, and the composition comprises about 1% to about 50% by weight iron cations based on the total weight of the composition not taking into account any water present in the composition.

In further embodiments, the cations are a mixture of rare earth cations and iron cations, and the composition the composition comprises about 1% to about 50% by weight cations based on the total weight of the composition not taking into account any water present in the composition. The mixture of cations can be any mixture in between 100% rare earth cations and 100% iron cations, and in certain embodiments the mixture can be a mixture of about 1:1 rare earth cations to iron cations (i.e., about 50% rare earth cations and 50% iron cations).

Although the process of the disclosure, for removing PVP from an aqueous feed and creating the hydrolyzed PVP (h-PVP) with ions bound to it, is primarily envisioned for removing PVP from industrial water sources, it will be understood that the process can be used to treat any aqueous liquid feed that contains undesirable amounts of PVP. Examples of such liquid feeds for these processes include, among others, wastewater, groundwater or runoff, tap water, well water, rainwater, surface waters, such as water from lakes, ponds and wetlands, agricultural waters, and geothermal fluids. In certain embodiments, the industrial water containing dissolved, undesired PVP also may contain some amount of dissolved or slurried rare earth cations from other industrial processes.

This effective and efficient method for removing dissolved PVP from a water source or aqueous stream comprises providing an aqueous stream having a first PVP concentration. As described above, this aqueous stream can be an industrial aqueous stream or any aqueous stream containing undesired, dissolved PVP. In the methods disclosed herein, the aqueous stream is hydrolyzed to provide an aqueous stream containing hydrolyzed PVP (h-PVP). Under alkaline conditions the γ-lactam ring of the PVP opens, which converts it into a γ-aminobutyric acid. Until the PVP is hydrolyzed, any amount of rare earth cations that may also be in the industrial aqueous stream will not bind with the PVP.

Polyvinylpyrrolidone (PVP) is a water-soluble polymer made from the monomer N-vinylpyrrolidone.

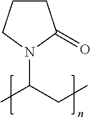

PVP is available in a range of molecular weights and related viscosities. Regardless of its molecular weight, it is highly soluble in polar solvents like water and difficult to remove and/or precipitate. All molecular weight PVP can be removed in the methods as disclosed herein.

Hydrolyzing PVP creates COO— substituents within the polymer to which the cations can bind. This hydrolysis reaction is as follows:

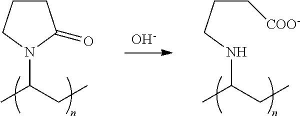

One of skill in the art understands that the % hydrolysis of the PVP is based upon the % of lactam rings opened to butyric acid substituents. See for example, Conix, A. and G. Smets, “Ring Opening in Lactam Polymers”, J. Polymer Sci., 1955, Vol. XV, p 221-229 and Frank, H.P. “The Lactam-Amino Acid Equilibria for Ethylpyrrolidone and Polyvinylpyrrolidone” J. Polymer Sci., 1954, Vol. XII, p 565-576. One of skill in the art also understands that the hydrolysis proceeds at a rate described by the rate equation: rate=k*[lactam]*[OH⁻]. Thus, one of skill in the art understands that the % hydrolysis of PVP can be controlled by varying the concentration of lactam (PVP), the concentration of base (OH⁻), the temperature, and the reaction time. As such, longer reaction times, higher temperatures, and/or higher concentrations of base would lead to more hydrolysis, with 100% hydrolysis being theoretically achievable, but economically costly and unnecessary given that the addition of rare earth cation, iron cation, or mixtures thereof is effective to remove the PVP even without 100% hydrolysis. Sufficient hydrolysis to allow coordination/binding of sufficient cations to precipitate the h-PVP with cations bound to it is the % hydrolysis needed to make the methods disclosed herein effective. As such, the % hydrolysis needs to be high enough to allow for the coordination of sufficient cations to precipitate the h-PVP with cations bound. This % hydrolysis may be from about 10% to about 75%. In certain embodiments the % hydrolysis is about 20% to about 75%.

On of skill in the art understands that the % hydrolysis may be measured by titrating conductometrically using a base such as NaOH and using a Philips GM 4249 conductometer, as described in Conix, A. and G. Smets, “Ring Opening in Lactam Polymers”, J. Polymer Sci., 1955, Vol. XV, p 221-229, the contents of which are hereby incorporated by reference in their entirety.

When the PVP composition containing h-PVP with ions bound is then to be utilized in methods for removing contaminants from an aqueous stream, a higher cation content is more favorable because the target contaminants absorb/bind to the cations.

As such, as used herein “hydrolyzed PVP” means PVP that is about 10% to about 75% hydrolyzed. In certain embodiments, “hydrolyzed PVP” means PVP that is about 20% to about 75% hydrolyzed. In other embodiments, “hydrolyzed PVP” means PVP that is about 40% to about 75% hydrolyzed. Hydrolyzed PVP as described herein can include PVP that is more than about 75% to about 100% hydrolyzed, but this higher degree of hydrolysis is not required.

The step of hydrolyzing the aqueous stream to provide the hydrolyzed PVP (h-PVP) includes any steps that open the pyrrolidone ring of the PVP to form polyvinyl aminobutyrate units. As such, COO— substituents are created and then available to react with the rare earth cations, iron cations, or mixtures thereof to create/provide an insoluble composition of hydrolyzed PVP (h-PVP) with cations bound to it.

In certain embodiments, the step of hydrolyzing the aqueous stream having a first PVP concentration to provide an aqueous stream containing h-PVP includes the steps of adding a base to pH adjust to about 10 to about 14; heating to about 35° C. to about 140° C. for about 1 hr to about 10 hr; cooling to about 20° C. to about 25° C.; and optionally adding an acid to pH adjust to about 6 to less than 8. The base used may be hydroxides or oxides of lithium, sodium, potassium, magnesium, calcium, and mixtures thereof, and the like. For example, the base can be 1M NaOH. When acid is used to adjust pH, the acid used may be hydrochloric, hydrobromic, hydroiodic, nitric, sulfuric, sulfurous, phosphoric, acetic, citric, and mixtures thereof, and the like.

In certain embodiments, the step of hydrolyzing the aqueous stream having a first PVP concentration may include oxidizing the aqueous stream before alkaline hydrolysis. This hydrolysis can be aided by first oxidizing the γ-lactam to a succinimide, as the succinimide is more easily hydrolyzed. Oxidizing may be done by adding any suitable oxidant including hydrogen peroxide, ozone, sodium peroxide, or mixtures thereof. Oxidation conditions can include temperatures ranging from about 20° C. to about 100° C. for about 1 hr to about 4 hr.

The aqueous stream containing h-PVP is then contacted with a rare earth salt, iron salt, or mixture of rare earth salts and iron salts to create h-PVP with cations bound to it. This composition comprises about 1% to about 50% by weight cations based on the total weight of the composition not taking into account any water present in the composition. In certain embodiments, the cations are rare earth cations. In other embodiments, the cations are a mixture of rare earth cations and iron cations. This PVP composition with cations bound to the h-PVP precipitates from the aqueous stream. After precipitation, the method provides a treated aqueous stream with a PVP concentration less than the first PVP concentration.

The h-PVP with cations bound can be isolated or removed from the treated aqueous stream by standard solid-liquid separation techniques such as settling and filtration. The precipitated solid (i.e., rare earth or iron hydrolyzed PVP) then can be used as an adsorption media to remove contaminants, including phosphate, from water. For example, the precipitated solid may be used as a soil amendment or within a filter.

The step of contacting the aqueous stream containing h-PVP with a salt, as disclosed herein, includes treating the aqueous stream with an amount of rare earth salts, iron salts, or mixtures thereof to provide the h-PVP with rare earth cations, iron cations, or mixtures thereof bound to the PVP. This creates an insoluble PVP composition that precipitates from the aqueous stream. As such, the method may further comprise a step of filtering the treated aqueous stream to remove the precipitated hydrolyzed PVP with cations bound. In other embodiments, the method may further comprise a step of decanting the treated aqueous stream to remove the precipitated hydrolyzed PVP with cations bound.

The aqueous stream containing h-PVP may be treated by contacting with a solution or a slurry of rare earth salt, iron salt, or mixture thereof. The slurry or solution is in water so an aqueous solution or slurry. Optionally, the anions of the salt also may be incorporated into the composition.

In general, the aqueous stream containing h-PVP is treated by exposing or contacting the aqueous stream with a solution or slurry containing the rare earth or iron cations or mixtures thereof. This solution or slurry containing the rare earth or iron cations is formed from a rare earth salt or iron salt in water. The rare earth salt or iron salt can be a soluble salt (creating a solution) or an insoluble salt suspended in a liquid (creating a slurry). The soluble salts can be chlorides, sulfates, sulfonates, nitrates, acetates, or mixtures thereof. The insoluble salts can be carbonates, hydroxides, oxides, or mixtures thereof. The liquid of the solution or slurry is water. In certain embodiments, the salts are rare earth chlorides and are an aqueous solution.

After the aqueous stream containing h-PVP is contacted with the rare earth or iron salt solution or slurry, the cations are bound to the h-PVP providing a h-PVP composition with cations bound to it. This composition is insoluble in water, and after isolation, it may be used for treating water as disclosed herein.

In certain embodiments, in addition to the rare earth and/or iron cations, the anions of the rare earth and/or iron salts also are incorporated into the PVP composition.

In these embodiments, the composition further comprises about 0.5% to about 10% by weight anions based on the total weight of the composition. In certain of these embodiments, the composition further comprises about 0.5% to about 5% by weight anions based on the total weight of the composition. The weight percent of anions based on the total weight of the composition is without taking into account any residual water in the composition.

In certain embodiments of removing PVP and preparing the h-PVP composition, rare earth salts are used. These rare earth salts can be salts of rare earths selected from the group consisting of cerium, lanthanum, yttrium, and mixtures thereof. In certain embodiments, the rare earth salts are salts of rare earths selected from the group consisting of cerium, lanthanum, and mixtures thereof.

In specific embodiments of removing PVP and preparing the composition, a rare earth chloride solution is used. The solution can be of rare earth chlorides selected from CeCl₃, LaCl₃, or a mixture of CeCl₃ and LaCl₃. The ratios of Ce to La in these rare earth chloride salts are described further herein and can be any ration from about 100% Ce to about 100% La.

In embodiments in which rare earth salts are used, the rare earth salts can be salts of rare earths selected from the group consisting of cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb) and yttrium (Y), and mixtures thereof. In certain embodiments, the rare earth salts and ultimate cations are light rare earths including cerium (Ce), lanthanum (La), praseodymium (Pr), neodymium (Nd), samarium (Sm), and mixtures thereof.

In certain embodiments, the rare earth salts are chloride salts and are a mixture of Ce and La and the balance (if any) being chloride salts of other rare earth elements, the other rare earth elements may be any one or more of the other rare earth elements. These other rare earth elements may be selected from the group consisting of Pr, Nd, Sm, Y, Dy, and mixtures thereof.

In an embodiment, the rare earth salt may be provided in hydrated crystal form (e.g., RECl₃·xH₂O (where x is 1 to 8)).

In certain embodiments, the rare earth chloride used to prepare the h-PVP composition is CeCl₃, LaCl₃, or a mixture of CeCl₃ and LaCl₃, all with less than 2% chloride salts of other rare earth elements based on the total rare earths. And in particular embodiments, the rare earth chloride used to prepare the h-PVP composition is CeCl₃, LaCl₃, or a mixture of CeCl₃ and LaCl₃, all with less than 1% chloride salts of other rare earth elements. These embodiments include any amount of Ce and La from a pure CeCl₃ to a pure LaCl₃ and all mixtures of CeCl₃ and LaCl₃ therebetween.

Common impurities found in rare earths salts as utilized herein include sodium, iron, lead, and uranium. In certain embodiments, the rare earth salt solutions or slurries contain less than approximately 10 g/L of these common impurities. The rare earth salt solutions or slurries can include less than approximately 9 g/L of sodium, less than approximately 20 mg/L iron, less than approximately 3 mg/L lead, and less than approximately 1 mg/L uranium.

The concentration of the rare earth chloride solution utilized can be about 0.01 mol/L to about 3.0 mol/L rare earth. In certain embodiments, the concentration of the rare earth chloride solution utilized can be about 2.0 mol/L to about 3.0 mol/L rare earth.

The hydrolyzed PVP (h-PVP) with ions bound to it can be isolated or removed from the treated aqueous stream by standard solid-liquid separation techniques, such as settling and filtration. As such, the method may further comprise a step of filtering the treated aqueous stream to remove the precipitated h-PVP with cations bound to it. In other embodiments, the method may further comprise allowing the precipitated h-PVP with cations bound to settle and decanting the treated aqueous stream. The method provides a treated aqueous stream with a PVP concentration less than the first/initial PVP concentration of the untreated aqueous stream.

In certain embodiments of the methods, the methods further include a step of drying the composition comprising h-PVP with ions bound. The composition can be dried at a temperature of about 40° C. to about 100° C. and more typically at a temperature of about 40° C. to about 75° C. and for about 30 mins to 24 hours and more typically for about 1 hour to about 12 hours.

In certain embodiments of the methods, the methods further include filtering, washing, and drying the resulting solid. The resulting solid is the h-PVP with ions (e.g., cations) bound to it, and this resulting solid may then be used to remove contaminants from an aqueous stream.

These PVP compositions may further comprise ions selected from the group consisting of sodium cations, chloride anions, nitrate anions, sulfate anions, sulfonate anions, carbonate anions, hydroxide anions, oxide anions, and mixtures thereof.

In certain embodiments, the methods for removing PVP from aqueous streams may further comprise the steps of setting a target concentration for PVP in the treated aqueous stream and wherein the treated aqueous stream has a PVP concentration that is at or below the target concentration.

In certain embodiments, the methods for removing PVP from aqueous streams may further comprise the steps of setting a target concentration for PVP in the treated aqueous stream, monitoring the PVP concentration in the treated stream, and comparing it to the target concentration.

The methods for removing dissolved and undesired PVP may be performed in a batch treatment or in a continuous system.

As such, the present application relates to methods for removing polyvinylpyrrolidone (PVP) from an aqueous stream, comprising: (i) providing an aqueous stream having a first PVP concentration; (ii) hydrolyzing the aqueous stream to provide an aqueous stream containing hydrolyzed PVP (h-PVP); (iii) contacting the aqueous stream containing h-PVP with a rare earth salt, iron salt, or mixture thereof to precipitate h-PVP with rare earth cations, iron cations, or mixtures thereof bound to the h-PVP; and (iv) providing a treated aqueous stream with a PVP concentration less than the first PVP concentration.

In one embodiment, rare earth salts are used. As such, the methods for removing polyvinylpyrrolidone (PVP) from an aqueous stream, comprise: (i) providing an aqueous stream having a first PVP concentration; (ii) hydrolyzing the aqueous stream to provide an aqueous stream containing h-PVP; (iii) contacting the aqueous stream containing h-PVP with a rare earth salt to precipitate h-PVP with rare earth cations bound to the PVP; and (iv) providing a treated aqueous stream with a PVP concentration less than the first PVP concentration.

In other embodiments iron salts are used and in further embodiments any mixture of rare earth salts and iron salts are used.

In certain embodiments, the rare earth ions, iron ions, or mixtures thereof may be present in the aqueous stream containing the PVP before the PVP is hydrolyzed. These ions may also result from industrial waste processes. The PVP will not react with these ions until hydrolyzed and will then precipitate.

These methods effectively and efficiently remove PVP from an aqueous stream. In some embodiments, the PVP concentration in the treated aqueous stream is about 20% to about 100% less than the first PVP concentration. In certain embodiments, the PVP concentration in the treated aqueous stream is about 50% to about 100% less than the first PVP concentration. In other embodiments, the PVP concentration is about 75% to about 100% less than the first PVP concentration.

As such, in some embodiments, about 50% to about 100% of the PVP is removed and in particular embodiments, about 75% to about 100% of the PVP is removed.

The present disclosure includes a new method which combines the hydrolysis of PVP with the addition of a rare earth salt, iron salt or mixture thereof, and this method provides for the removal of the PVP by standard solid-liquid separation techniques such as settling and filtration. To remove PVP from an aqueous feed and make the compositions, the rare earth salts or iron salts may be provided as a solution or slurry that is contacted with the water containing h-PVP. Thus, PVP is removed from an aqueous feed and also creates a composition comprising h-PVP with ions bound to it.

Although the process of the disclosure for removing PVP from an aqueous feed and creating the h-PVP with ions bound to it is primarily envisioned for removing PVP from industrial water sources, it will be understood that the process can be used to treat any aqueous liquid feed that contains undesirable amounts of PVP. Examples of such liquid feeds for this process include, among others, wastewater, groundwater or runoff, tap water, well water, rainwater, surface waters, such as water from lakes, ponds and wetlands, agricultural waters, and geothermal fluids.

The present application additionally relates to methods of treating aqueous feeds using these compositions comprising h-PVP with ions bound to it. The methods of treating the aqueous feeds using the h-PVP with ions bound to it as disclosed herein may include the steps for making these compositions (of h-PVP with ions bound) within an integrated method, as described in further detail below.

When used to treat an aqueous feed, the compositions, comprising h-PVP with ions bound to it, remove contaminants from the aqueous feed to provide an effluent/treated aqueous stream with a reduced concentration of contaminants relative to the untreated feed. The treated stream may have a reduced concentration of contaminants that achieves a target concentration or that is below a target concentration. Depending on the structure in which it is used, the h-PVP composition with ions bound to it may be refreshed after a certain period of time treating contaminated water. Using the h-PVP composition with ions bound allows for effective and efficient treatment of aqueous feeds to remove contaminants. Without being bound by any theory, it is believed that the contaminants absorb to the rare earth cations and/or iron cations bound to the h-PVP composition and thus, prevent contaminants from passing through. As such, contacting of the contaminants with the cations leads to the contaminant one or more of absorbing and/or reacting with the cations.

Although the process of the disclosure for using the h-PVP composition with ions bound is primarily envisioned for removing contaminants from water, groundwater or runoff, it will be understood that the process can be used to treat any aqueous liquid feed that contains undesirable amounts of contaminants. Examples of such liquid feeds include, among others, tap water, well water, rainwater, surface waters, such as water from lakes, ponds and wetlands, agricultural waters, wastewater from industrial processes, runoff, and geothermal fluids.

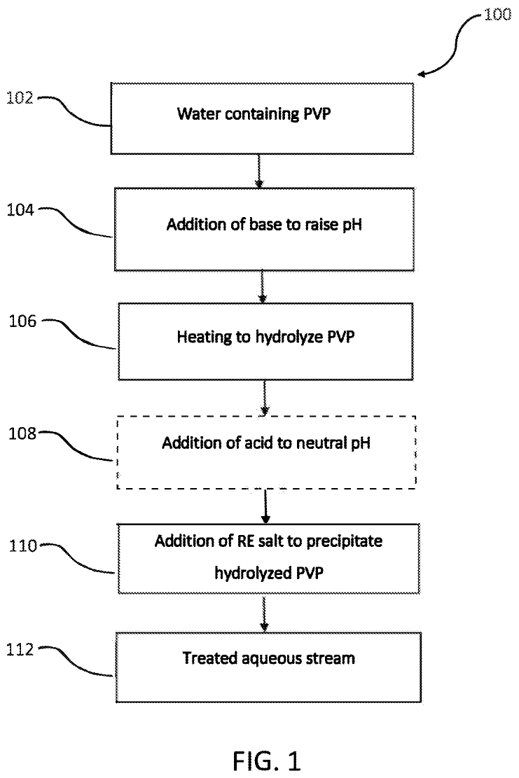

FIG. 1 illustrates a general flow diagram of treating water to remove PVP by first hydrolysis of the PVP and then addition of rare earth or iron salts. In the method 100, water containing a first PVP concentration is provided (102). The PVP is hydrolyzed by adding a base to raise the pH (to about 10 to 14) (104) and heating (to about 35° C. to about 140° C. for about 1 hr to about 10 hr) (106). After cooling (to about 20° C. to about 25° C.) optionally an acid is added to adjust the pH to neutral (about 5 to less than about 8) (108). These steps hydrolyze the PVP. The aqueous stream containing h-PVP is mixed with a rare earth salt to precipitate the h-PVP. This provides a treated aqueous stream with a PVP concentration that is less than the first PVP concentration.

### Composition for Treating Water

The methods for removing dissolved and undesired PVP make a composition for treating water. This composition comprises (a) hydrolyzed PVP (h-PVP) (b) rare earth cations, iron cations, or mixtures thereof, wherein the cations are bound to the h-PVP and wherein the composition comprises about 1% to about 50% by weight cations based on the total weight of the composition. In certain embodiments, the composition comprises about 10% to about 40% by weight cations based on the total weight of the composition. The weight percent of cations based on the total weight of the composition is without taking into account any residual water in the composition. In certain of these embodiments, the cations are rare earth cations.

The composition may further incorporate anions from the salt used to deposit the cations (e.g., rare earth cations). In embodiments further comprising anions, the composition further comprises about 0.5% to about 10% by weight anions based on the total weight of the composition. In certain of these embodiments, the composition comprises about 0.5% to about 5% by weight anions based on the total weight of the composition. The weight percent of anions based on the total weight of the composition is without taking into account any residual water in the composition.

As such, the present application relates to a composition for treating water including h-PVP with ions bound to it. These compositions may be used within a soil amendment or a filter. The ions are selected from rare earth cations, iron cations, or mixtures thereof. In one embodiment, the ions are rare earth cations. In another embodiment, the ions are iron cations. In yet another embodiment, the ions may be a mixture of rare earth cations and iron cations. This mixture may be any mixture between 100% rare earth cations and 100% iron cations and in certain embodiments is about 1:1 rare earth cations to iron cations. The ions also can be ions from the solution/slurry used to deposition the rare earth cations and/or iron cations. These ions can include the anions of the rare earth salts and/or iron salts.

As such, this composition includes h-PVP and ions selected from rare earth cations, iron cations, and mixtures thereof, wherein the ions are bound to the h-PVP. These ions also can include the anions of the salts used to deposit the rare earth and/or iron cations. The ions of the composition may further include sodium, chloride, nitrate, sulfate, sulfonate, acetate, and mixtures thereof.

Without being bound by any theory, it is believed that contaminants absorb to the rare earth cations, iron cations, and mixtures thereof. Accordingly, these compositions may be used for water treatment and used in structures for filtering/capturing contaminated water. These compositions may be used within a soil amendment or within a filter.

As described herein, the h-PVP has ions selected from rare earth cations, iron cations, or mixtures thereof bound to it, or associated with it, in some manner. The rare earth cations or iron cations may be associated with the h-PVP by any type of attraction, including a van der waals type association, a covalent bond, or an ionic bond. Accordingly, as described herein, the h-PVP with bound or associated rare earth cations or iron cations includes both unbound attraction and chemically bound. In certain embodiments, the cations are bound through ionic bonds of the cations to the carboxylate (COO⁻) of the hydrolyzed PVP. Enough cations need to be associated/bound to precipitate the PVP and to then remove contaminants.

As described herein, hydrolyzed means about 10% to about 75% hydrolyzed and in certain embodiments about 10% to about 75% hydrolyzed, and in particular embodiments about 40% to about 75% hydrolyzed. Hydrolyzed as described herein can include more than about 75% to about 100% hydrolyzed as well, but this higher degree of hydrolysis is not required. The % hydrolyzed is a measurement of the % lactam rings that are opened to COO— substituents within the PVP polymer to which the rare earth cations and/or iron cations can bind.

In the present compositions, the ions bound to the h-PVP are rare earth cations, iron cations, or mixtures thereof. In certain embodiments the ions are rare earth cations. In other embodiments, the ions are iron cations. And in further embodiments, the ions are a mixture of iron cations and rare earth cations.

The composition as described herein may be a powder or particles or may have any form and/or shape that exposes a maximum of the ions bound to the h-PVP to the contaminant. As such, the composition may be in a fixed bed or may be shaped or pressed into pellets, granules, and/or beads, or may be supported on a polymeric structure.

When the ions bound to the composition/soil amendment of h-PVP are rare earth cations, the rare earth cations are deposited on the PVP from rare earth compounds, such as rare earth salts. In certain embodiments, the rare earth compounds are rare earth salts that are water soluble or water insoluble. For example, in certain embodiments, the rare earth salts are water soluble and include chlorides, nitrates, sulfates, sulfonates, acetates, and mixtures thereof. In other embodiments, the rare earth salts are water insoluble and include carbonates, hydroxides, oxides, and mixtures thereof. The anion of the salt also may be incorporated into the composition. As such, the anion of the salt may be incorporated by also being bound to the h-PVP and/or by some amount of anion remaining bound to/coordinated with the rare earth cation.

In these embodiments, the compositions as disclosed herein, comprising h-PVP and rare earth cations bound to the h-PVP, also may further comprise the anions of the salt used to deposit the rare earth cations. In specific embodiments, the composition may further comprise anions selected from the group consisting of chlorides, nitrates, sulfates, sulfonates, carbonates, hydroxides, oxides, and mixtures thereof. These anions may be bound to the h-PVP and/or by some amount of anion remaining bound to/coordinated with the rare earth cation. In certain of these embodiments, the composition further comprises anions selected from the group consisting of chlorides, nitrates, sulfates, sulfonates, acetates, and mixtures thereof. In certain embodiments, the composition may further comprise sodium ions.

When the ions bound to the composition/soil amendment of h-PVP are iron cations, the iron cations are deposited on the h-PVP from iron compounds, such as iron salts. In certain embodiments, the iron compounds are iron salts that are water soluble or water insoluble. For example, in certain embodiments, the iron salts are water soluble and include chlorides, nitrates, sulfates, sulfonates, acetates, and mixtures thereof In other embodiments, the iron salts are water insoluble and include carbonates, hydroxides, oxides, and mixtures thereof. The anion of the salt also may be incorporated into the composition. As such, the anion of the salt may be incorporated by also being bound to the h-PVP and/or by some amount of anion remaining bound to/coordinated with the iron cation.

In these embodiments, the compositions as disclosed herein, comprising h-PVP and iron cations bound to the h-PVP, also may further comprise the anions of the salt used to deposit the iron cations. In specific embodiments, the composition may further comprise anions selected from the group consisting of chlorides, nitrates, sulfates, sulfonates, carbonates, hydroxides, oxides, and mixtures thereof. These anions may be bound to the h-PVP and/or by some amount of anion remaining bound to/coordinated with the iron cation. In certain of these embodiments, the composition further comprises anions selected from the group consisting of chlorides, nitrates, sulfates, sulfonates, acetates, and mixtures thereof. In certain embodiments, the composition may further comprise sodium ions.

Corresponding compositions also can comprise h-PVP and a mixture of iron cations and rare earth cations.

The precipitated solid h-PVP with ions bound can be used as an adsorption media to remove contaminants, including phosphate, from water. As such, the present disclosure addresses the need for removing PVP from water and also creates a use for an otherwise waste product. In a specific embodiment, the h-PVP has rare earth cations bound and can be used within a soil amendment or filter for removing contaminants from water.

The composition (i.e., filter/soil amendment) composed of h-PVP with ions bound to it can remove contaminants (the “target contaminant”) from a liquid feed. Target contaminants include phosphates, phosphorus containing compounds, arsenic, arsenic containing compounds, PFAS, fluorides, and the like, and mixtures thereof In certain embodiments, the contaminants are phosphates, phosphorus containing compounds arsenic, arsenic containing compounds, PFAS, fluorides, or mixtures thereof.

As described herein, perfluoroalkyl substances (PFAS) include compounds such as perfluorooctanesulfonate (PFOS), perfluorohexanesulfonate (PFHxS), Nafion by-product 2, 6:2 fluorotelomer sulfonate (6:2 FTSA), 8:2 FTSA, perfluorobutanesulfonate (PFBS), F-53B, and the like. Perfluoroalkyl substances (PFAS) are as described in “A guide to the PFAS found in our environment. Chemical structures and origins of per-and polyfluoroalky substances that are polluting our world”, C&EN: CAS (a division of the American Chemical Society) (2020) https://cen.acs.org/sections/pfas.html, the contents of which are incorporated by reference in their entirety.

The soil amendment/filter compositions of h-PVP with ions bound are useful for removing contaminants from an aqueous stream. As described, the aqueous stream can be one or more of a drinking water, rainwater, runoff, and groundwater source that contain undesirable amounts of contaminants. Furthermore, the aqueous stream can include without limitation well waters, surface waters (such as water from lakes, ponds and wetlands), agricultural waters, wastewater from industrial processes, and geothermal waters.

When the ions are rare earth (RE) cations, the rare earth cations are cations of cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb) and yttrium (Y), or mixtures thereof. In certain embodiments, the rare earth cations are light rare earth cations including cerium (Ce), lanthanum (La), praseodymium (Pr), neodymium (Nd), samarium (Sm), or mixtures thereof.

In certain embodiments, the rare earth cations are selected from the group consisting of cerium, lanthanum, yttrium, and mixtures thereof. In other embodiments, the rare earth cations are selected from the group consisting of cerium, lanthanum, and mixtures thereof.

In particular embodiments, the rare earth cations are Ce, La, or a mixture of Ce and La. In these embodiments, trace amounts (i.e., less than 2%, and in some embodiments less than 1%, by weight of the total weight of rare earth cations) of other rare earth cations may be present. In certain embodiments, these other rare earth cations may be one or more of the light rare earth cations. These embodiments include any amount of Ce and La from pure Ce cations to pure La cations and all mixtures of Ce and La therebetween.

These weight or mol percentages for mixtures of rare earth cations or “pure” rare earth cations are for the rare earth cations relative to other rare earth cations and are not with regard to the overall composition.

In certain embodiments, the rare earth cations are “pure”. As used herein, “pure” cations are 95% or greater of that rare earth by mol, relative to total mol of all rare earth cations present, with any balance being any other rare earth cations.

For example, pure cerium is 95% or greater cerium cations, relative to the total mol of all rare earth cations in the composition. Pure lanthanum is 95% or greater lanthanum cations; pure neodymium is 95% or greater neodymium cations; pure yttrium is 95% or greater yttrium cation; and the like. In some embodiments a “pure” rare earth cation may be 99% or greater of that rare earth, relative to total mol of all rare earths present, and any balance being other rare earths. For example, the rare earth cations may be 99% or greater cerium, relative to the total mol of all rare earth cations in the composition or 99% or greater lanthanum, relative to the total mol of all rare earth cations.

The rare earth cations may be any mixture of cerium and lanthanum, including, for example, from 99.9% cerium and 0.1% lanthanum to 0.1% cerium and 99.9% lanthanum and all mixtures therebetween.

As described above, the anions of the rare earth salt used to create the composition also may be incorporated into the compositions. When part of the composition, the anions may be bound to the PVP and/or may remain associated with/bound to the rare earth cations.

In certain embodiments of the h-PVP with rare earth cations bound to it, the rare earth cations are a mixture of Ce and La, being 55.0-75.0% by weight Ce, from 25.0-45.0% by weight La, and any balance being other rare earths, based on the total weight of rare earth cations present. In one particular embodiment, the rare earth cations are a mixture of Ce and La, being 55.0-75.0% by weight Ce and 25.0-45.0% La by weight, and the balance of other rare earth cations being less than 2% by weight, based on the total weight of rare earths. In certain embodiments, the balance of other rare earth cations is less than 1% by weight, based on the total weight of rare earths.

The rare earth cations may be 59.8-70.1% Ce by weight and 29.9-40.1% La by weight, of 63.0-69.0% Ce by weight and 30.0-36.0% La by weight, and of 64.0-68.0% Ce by weight and 31.0-35.0% La by weight based on the total weight of rare earth cations present (with or without trace amounts of other rare earth cations). In a specific embodiment, the rare earth cations are 59.8-70.1% by weight Ce, 29.9-40.1% by weight La, and any balance of being one or more other rare earth cations, wherein the balance is less than 1% by weight, based on the total weight of rare earth cations present.

In additional embodiments, the rare earth cations are 60.0-65.5% mol Ce and 30.0-40.0% mol La based on the total moles of rare earth cations and any balance being one or more other rare earths.

Additional embodiments include rare earth cations of 59.8-70.1% Ce and 29.9-40.1% La, of 63.0-69.0% Ce and 30.0-36.0% La, and of 63.0-68.0% Ce and 31.0-35.0% La (all with any balance being one or more other rare earths and all based on the total moles rare earths) based on the total moles of rare earth cations. In certain embodiments, the balance of any other rare earth cations is less than 2% or less than 1%.

The other rare earth cations that may be present are any one or more of the other rare earths. In certain embodiments, these other rare earth cations may be selected from the group consisting of Pr, Nd, Sm, Y, and mixtures thereof.

Embodiments including rare earth cations also include a mixture of Ce and La with 25.0-35.0% Ce and 12.0-20.0% La and the balance being other rare earths. In certain of these embodiments, the balance of other rare earth cations is greater than about 45% or is about 50% or greater. The balance may be a single rare earth cation or mixture of rare earth cations (that are not Ce and La). For example, the other rare earth cations may be about 50% Y, or about 50% Sm, or a mixture of about 25% Sm and about 25% Y.

In certain embodiments, the rare earth cations are Ce, La, or a mixture of Ce and La, all with less than 2% of other rare earths. In particular embodiments, the rare earth cations are Ce, La, or a mixture of Ce and La, all with less than 1% of other rare earths.

For the purposes of this description unless otherwise specified, % of rare earth cations versus other rare earth cation(s) is % of rare earth cation by mol relative to total mol of all rare earth cations in the composition, without regard to any anion (such as chloride or nitrate) if the rare earth remains coordinated with an anion from its salt form. Similarly, if the % of one rare earth cation versus other rare earth cation(s) is identified as weight %, it is relative to total weight of all rare earth cations in the composition, without regard to any anion (such as chloride or nitrate) if the rare earth remains coordinated with an anion from its salt form. Common impurities found in rare earths as utilized herein include sodium, iron, lead, and uranium.

When used for treating contaminated water, the composition may be within a soil amendment or filter. As such, the soil amendment or filer comprises h-PVP and ions (e.g., rare earth cations, iron cations, or mixtures thereof) bound to the h-PVP. The composition comprises about 1% to about 50% by weight cations based on the total weight of the composition. In certain embodiments, the composition comprises about 10% to about 40% by weight cations based on the total weight of the composition. In certain embodiments, these cations are rare earth cations. In other embodiments, these cations are iron cations. These are weight percentages based on the total weight of the composition, not taking into account any residual water in the composition. In some embodiments, the compositions may be dry or dried such that there is no or minimal water and in other embodiments, the compositions may contain residual water, including significant amounts of residual water.

In some embodiments the composition may further comprise anions, and the composition comprises about 0.5% to about 10% by weight anions based on the total weight of the composition. In certain of these embodiments, the composition comprises about 0.5% to about 5% by weight anions based on the total weight of the composition. These are weight percentages based on the total weight of the composition, not taking into account any residual water in the composition. In certain embodiments these anions are selected from the group consisting of chloride, nitrate, sulfate, sulfonate, acetate, and mixtures thereof.

The carboxylate (COO⁻) functional groups of the h-PVP are available to bind with the ions. The COO⁻ functional groups also may bind with water.

In certain embodiments, the composition comprises h-PVP and rare earth (RE) cations bound thereto and the composition may be of the formula: REₓ(h-PVP)_{y}Cl_{z} or REₓ(h-PVP)_{y}(NO₃)_{z} wherein x is about 0.002 to about 1, y is about 1, and z is about 0.0008 to about 2. In certain embodiments x is about 0.3, y is about 1, and z is about 0.085.

It is believed that in the above formula, as x increases z would increase too (approximately linearly with each other) while keeping y constant. The highest x:y ratio would be approximately 1:1 and the highest x:y:z ratio is approximately 1:1:2. The lowest x:y:z ratio would be approximately 0.002:1:0.0008.

In other embodiments, the composition comprises h-PVP and iron cations bound thereto. In these embodiments, the composition may be of the formula: Feₓ(h-PVP)_{y}Cl_{z} or Feₓ(h-PVP)_{y}(NO₃)_{z} wherein x is about 0.002 to about 1, y is about 1, and z is about 0.0008 to about 2. In certain embodiments x is about 0.4, y is about 1, and z is about 0.015. In the chloride embodiment, there is more Fe present relative to the h-PVP because it is a smaller cation and the Cl is lower because the h-PVP can wrap around it easier, which leaves less space for Cl to be incorporated. The highest x:y ratio would be approximately 1:1 and the highest x:y:z ratio is approximately 1:1:2. The lowest x:y:z ratio would be approximately 0.002:1:0.0008.

### Methods of Using the Compositions for Treating Water

The present application relates to methods of treating contaminated water with a composition comprising (a) h-PVP and (b) cations selected from rare earth cations, iron cations, or mixtures thereof, wherein the cations are bound to the h-PVP and wherein the composition comprises about 1% to about 50% by weight of the cations based on the total weight of the composition. In certain embodiments, the cations are rare earth cations and in other embodiments, the cations are iron cations. The weight percent of cations based on the total weight of the composition is without taking into account any residual water in the composition.

While not wanting to be bound by any theory, it is believed that the contaminant in the aqueous stream is removed by contacting with the cations bound to the hydrolyzed PVP of the composition as disclosed herein. It is believed that contacting of the contaminant in the aqueous stream with the cations bound to the PVP leads to the contaminant one or more of absorbing and/or reacting with the cations. As such, some, most, or all, of the contaminant contained in the contaminated aqueous stream is removed from the aqueous stream/feed by contacting with the compositions as described herein.

Using the compositions as disclosed herein to treat contaminated water allows for the efficient operation of the water treatment method and provides an effluent/treated stream with reduced concentrations of contaminant in comparison to the water prior to treatment.

The method for removing contaminants from an aqueous stream comprises the steps of (i) contacting an aqueous stream having a first contaminant concentration with a composition comprising (a) h-PVP and (b) cations selected from rare earth cations, iron cations, or mixtures thereof, wherein the cations are bound to the h-PVP and wherein the composition comprises about 1% to about 50% by weight of the cations based on the total weight of the composition; (ii) removing contaminant from the aqueous stream by contact of the aqueous stream with the composition; and (iii) providing an aqueous stream with a second contaminant concentration less than the first contaminant concentration.

In the methods as described herein, the contaminant is selected from the group consisting of phosphate, phosphorus containing compounds, arsenic, arsenic containing compounds, PFAS, fluorides, and mixtures thereof.

In some embodiments, the method of treating water to remove contaminants uses a composition having rare earth cations bound to the h-PVP. In other embodiments, a composition having iron cations bound to the h-PVP are used.

In certain embodiments, these methods remove provide a treated aqueous stream wherein the second contaminant concentration is about 50% to about 90% less than the first contaminant concentration. In some embodiments, the second contaminant concentration is about 50% to about 100% less than the first contaminant concentration.

In certain embodiments, these methods remove at least about 50%, or at least about 75%, or at least about 80%, or at least about 85%, or at least about 90%, or at least about 95%, or at least about 99% of the contaminant. In the most efficient embodiments, the contaminant is removed at least about 90% or more or is removed to less than the limit of detection. As such, in some embodiments the contaminant may be removed to a level at which it is undetectable. The contaminant removed is phosphate, phosphorus containing compounds, arsenic, arsenic containing compounds, PFAS, fluorides, or mixtures thereof.

The methods of treating water to remove contaminants optionally may further comprise one or more steps of setting a target level of contaminant to be removed and/or monitoring the treated stream/effluent for the contaminant. The methods additionally may comprise the step of replacing or renewing the composition comprising the h-PVP with ions bound to it if after a period of time or after the contaminant level in the treated stream/effluent beings to increase above (or exceed) the set target or generally beings to increase.

In certain embodiments, the contaminants to be removed from the water stream are phosphates, phosphorus containing compounds, and mixtures thereof. Treating water by passing it through a composition as described herein provides a treated stream/effluent with a reduced concentration of phosphorus in comparison to the water feed. Phosphates and phosphorus containing compounds are monitored by the concentration of phosphorous in the treated stream. The treated stream can have a concentration of phosphorus equal to or less than a target concentration of phosphorus. As such, the method may further comprise the step of setting a target concentration of phosphorus and/or monitoring the treated stream/effluent for phosphorus. When removing phosphorus and a composition containing rare earth cations, the composition may be present in an amount to provide a rare earth (RE):phosphorus (P) molar ratio of approximately 0.1:1 RE:P to approximately 0.8:1 RE:P.

In certain embodiments, the contaminants to be removed from the water stream are arsenic, arsenic containing compounds, or mixtures thereof. Treating water by passing it through a composition as described herein provides a treated stream/effluent with a reduced concentration of arsenic in comparison to the water feed. The treated stream can have a concentration of arsenic equal to or less than a target concentration of arsenic. As such, the method may further comprise the step of setting a target concentration of arsenic and/or monitoring the treated stream/effluent for arsenic.

In certain embodiments, the contaminants to be removed from the water stream are PFAS. Treating water by passing it through a composition as described herein provides a treated stream/effluent with a reduced concentration of PFAS in comparison to the water feed. The treated stream can have a concentration of PFAS equal to or less than a target concentration of PFAS. As such, the method may further comprise the step of setting a target concentration of PFAS and/or monitoring the treated stream/effluent for PFAS.

In certain embodiments, the contaminants to be removed from the water stream are fluorides. Treating water by passing it through a composition as described herein provides a treated stream/effluent with a reduced concentration of fluorides in comparison to the water feed. The treated stream can have a concentration of fluorides equal to or less than a target concentration of fluorides. As such, the method may further comprise the step of setting a target concentration of fluorides and/or monitoring the treated stream/effluent for fluorides.

The concentration of contaminant in the treated stream/effluent after passing through the composition as described herein can be about or can be set (as a target concentration) at the limit of detection. The concentration of contaminant after passing through the compositions as described herein also can be set at a target concentration based on EPA guidances, standards, or regulations. Then the actual (or measured) concentration of contaminant in the treated stream/effluent after treatment can be equal to or less than this target concentration.

The target concentration also can be set as a percentage reduction of the contaminant in the effluent (treated aqueous stream) versus the concentration in the feed. In certain embodiments, the effluent concentration of contaminant can be about 0.5% to about 100% less than the feed concentrate. In certain embodiments, the effluent concentration of contaminant is about 5% to about 50% less than the feed concentration. In other embodiments, the effluent concentration of contaminant is about 10% to about 50% less than the feed concentration. In other embodiments, the effluent concentration of contaminant is about 50% to about 100% less than the feed concentration.

In some embodiments, the material comprising the compositions as described herein may be contained within a structure so that the aqueous feed flows through the structure containing the composition for treating water. The composition for treating water may be contained within a smaller structure within the overall structure through which the water flows. If within a smaller structure, when the compositions for treating water as described herein become less effective in removing contaminants over time, the composition may be replaced or refreshed without disrupting the overall structure within which it is contained. As such, the smaller structure containing the h-PVP compositions with ions bound may be close to the inlet of the overall structure or may be close to the outlet of the overall structure so that the aqueous feed flows through it, but it can readily be replaced or refreshed as needed.

In these embodiments, the method may further comprise the steps of setting a target concentration for contaminant; monitoring the concentration of contaminant in the treated stream, and/or replacing or refreshing the h-PVP composition as described herein when the concentration of contaminant increases above (or exceeds) the target concentration. In these embodiments, the replacing or refreshing of the composition includes retreatment of the h-PVP with a rare earth and/or iron salt solution/slurry as described herein. As such, the h-PVP is contacted with rare earth (or iron) salts in water again.

In some embodiments, the contaminant-containing aqueous stream is passed through an inlet into a vessel at a temperature and pressure, usually at ambient temperature and pressure, such that the water of the contaminant-containing aqueous stream remains in the liquid state. In this vessel the contaminant-containing aqueous stream is contacted with the composition as described herein. The contacting of the composition with the contaminant-containing aqueous stream leads to the contaminant one or more of absorbing and/or reacting with cations of the h-PVP composition, and in particular, with the rare earth cations and/or iron cations. This removes the contaminant from the aqueous stream.

In some embodiments, the compositions for treating water as described herein can be deposited on a support material, such as a polyurethane foam or a polyethylene. Furthermore, the compositions for treating water can be deposited on one or more external and/or internal surfaces of the support material. It can be appreciated that persons of ordinary skill in the art generally refer to the internal surfaces of the support material as pores. The composition can be supported on the support material with or without a binder. In some embodiments, the composition can be applied to the support material using any conventional techniques such as slurry deposition.

In some embodiments, the composition for treating water as described herein is slurried with the contaminant-containing aqueous stream. It can be appreciated that the composition for treating water and the contaminant-containing aqueous stream are contacted when they are slurried. While not wanting to be bound by any theory, it is believed that some amount, if not most or all, of the contaminant contained in the aqueous stream is removed from the aqueous stream by the slurring and/or contacting of the h-PVP composition with the contaminant-containing aqueous stream. Following the slurring and/or contacting of the h-PVP composition with the contaminant-containing aqueous stream, the slurry is filtered by any known solid liquid separation method. Optionally, the filtered and treated aqueous stream can be monitored for the contaminant. The filtered and treated aqueous stream can have a contaminant concentration equal to or less than a target concentration.

The methods as described herein remove at least “some” of the target contaminant. The term “some” refers to removing about 10% to about 50% of the contaminant contained in the aqueous stream. More generally, the term “some” refers to one or more of removing about 10%, about 20%, about 30%, about 40%, or about 50% of the contaminant contained in the aqueous stream.

In certain embodiments, the methods as described herein remove “most” of the target contaminant. The term “most” refers to removing more than about 50% to about 90% of the contaminant contained in the aqueous stream. More commonly, the term “most” refers to removing about 60%, about 70%, or about 90% of the contaminant contained in the aqueous stream.

In certain embodiments, the methods as described herein remove “all” of the target contaminant. The term “all” refers to removing more than about 90% to about 100% of the contaminant contained in the aqueous stream. More generally, the term “all” refers to removing more than 98%, 99%, 99.5%, or 99.9% of the contaminant contained in the aqueous stream.

In certain embodiments, these methods remove at least about 75%, or at least about 80%, or at least about 85%, or at least about 90%, or at least about 95%, or at least about 99% of the contaminant contained in the aqueous. In most efficient embodiments, the contaminant is removed at least about 95%.

In some embodiments, the composition for treating water as described herein is in the form of a soil amendment or a filter.

In some embodiments, the composition for treating water as described herein is in the form of a fixed bed. Moreover, the fixed bed of the composition is normally comprised of the composition in the form of particles. These particles can have any shape and/or form that exposes a maximum of the h-PVP particle surface area to the aqueous liquid and the flow of the aqueous liquid through the bed with minimal back pressure. However, if desired, the h-PVP particles may be in the form of a shaped body such as beads, extrudates, porous polymeric structures or monoliths. In some embodiments, the h-PVP composition as described herein can be supported as a layer and/or coating on such beads, extrudates, porous polymeric structures or monolith supports.

In some embodiments, the h-PVP composition is contained within a smaller structure within the overall fixed bed so it can be removed and refreshed/replaced after a period of time if desired or needed. In these embodiments, the contaminant concentration in the treated stream can be monitored and the h-PVP composition can be removed and refreshed/replaced when the contaminant concentration in the treated stream is above a target concentration or when it begins to increase measurably.

The contacting of the composition for treating water as described herein with the contaminant-containing aqueous stream normally takes place at a temperature from about 4 to about 100 degrees Celsius, more normally from about 5 to about 40 degrees Celsius. In certain embodiments, the contacting takes place at ambient temperature (about 18 to about 25 degrees Celsius). Furthermore, the contacting of the composition with the contaminant-containing stream commonly takes place at a pH of from about pH 3 to about pH 8.

The contacting of the h-PVP composition with contaminant-containing aqueous stream generally occurs over a period of time of more than about 30 seconds to about 5 days, generally about 30 seconds to about 24 hours, and more generally for a period of time of about 30 seconds to about 5 hours. The removal of contaminant may increase with an increase in contact time.

Treatment of contaminated water by the compositions as described herein can be performed by passing the contaminated water through the h-PVP composition having ions bound to it. In doing so, some pressure may be created to push the water though the h-PVP composition. In other embodiments, the water flows freely through the h-PVP composition.

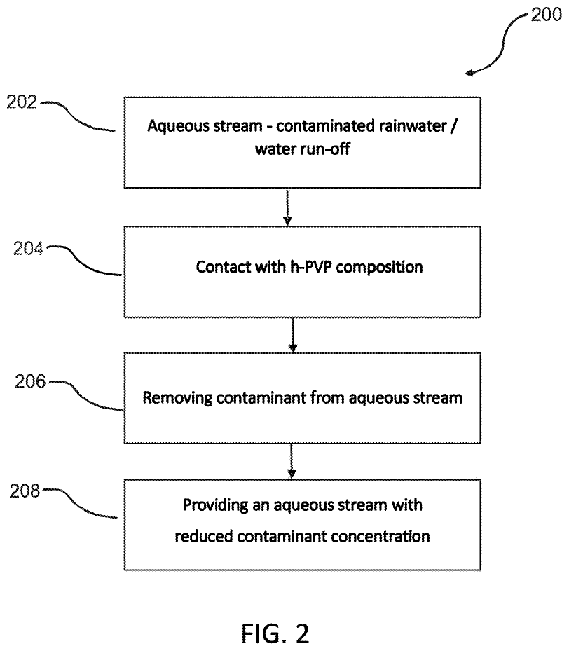

FIG. 2 illustrates a general flow diagram of using the h-PVP composition for treating water and removing contaminants from an aqueous stream. In the method 200, an aqueous stream to be treated is contaminated rainwater and/or water run-off (202). The contaminant can be phosphate, phosphorus containing compounds, arsenic, arsenic containing compounds, PFAS, fluorides, or mixtures thereof. The contaminated aqueous stream is contacted with the composition as described herein containing a h-PVP with cations bound thereto (204). Contacting of the aqueous stream with the composition as described herein removes contaminant from the aqueous stream (206). An aqueous stream with a contaminant concentration less than the initial contaminant concentration is provided (208).

The method may remove at least about 75%, or at least about 80%, or at least about 85%, or at least about 90%, or at least about 95%, or at least about 99% of the contaminant. In the most efficient embodiments, the contaminant is removed at least about 90% or to the limit of detection. In some embodiments the contaminant may be removed to a level at which it is undetectable.

The method of treating water optionally may further comprise one or more steps of setting a target level of contaminant to be removed from the contaminated aqueous stream of (202) and/or monitoring the provided aqueous stream with reduced contaminant concentration of (208) for the level of contaminant. The method additionally may comprise the step of replacing or renewing the h-PVP composition after a period of time or after the contaminant level in the treated aqueous stream of (208) beings to increase above (or exceed) the set target or generally begins to increase.

### Integrated Methods

The present application also relates to integrated methods for removing PVP from water and then using what would otherwise be a waste product to treat aqueous streams to remove other contaminants. As such, the present disclosure provides efficient and environmentally friendly methods for treating aqueous streams.

The integrated methods as disclosed herein combine the methods for removing PVP from an aqueous stream with methods of treating aqueous streams to remove contaminants selected from the group consisting of phosphate, phosphorus containing compounds, arsenic, arsenic containing compounds, PFAS, fluorides, and mixtures thereof. These methods use the h-PVP with cations bound to it created in the first part of the integrated method to then treat a different aqueous stream to remove contaminants selected from the group consisting of phosphate, phosphorus containing compounds, arsenic, arsenic containing compounds, PFAS, fluorides, and mixtures thereof in the second part of the integrated method.

As such, the integrated method for removing polyvinylpyrrolidone (PVP) from a first aqueous stream and recycling the removed PVP to remove contaminants from a second aqueous stream comprises the steps of: (i) providing a first aqueous stream having a first PVP concentration; (ii) hydrolyzing the first aqueous stream to provide an aqueous stream containing h-PVP; (iii) contacting the aqueous stream containing h-PVP with a rare earth salt, an iron salt, or a mixture thereof to precipitate h-PVP with cations bound to the h-PVP, wherein the cations are selected from rare earth cations, iron cations or mixtures thereof; and (iv) isolating the precipitated h-PVP with cations bound; (v) contacting a second aqueous stream having a first contaminant concentration with the precipitated h-PVP with cations bound and removing contaminants from the second aqueous stream; and (vi) providing a treated stream with a second contaminant concentration less than the first contaminant concentration, wherein the contaminant is selected from the group consisting of phosphate, phosphorus containing compounds, arsenic, arsenic containing compounds, PFAS, fluorides, and mixtures thereof.

As such, the present disclosure includes a new method which combines the hydrolysis of PVP with the addition of a rare earth salt, iron salt, or mixture thereof, and this method provides for the removal of the PVP by standard solid-liquid separation techniques such as settling and filtration. The precipitated solid (i.e., rare earth or iron h-PVP) then can be used as an adsorption media to remove contaminants, including phosphate, from water. As such, the present disclosure addresses the need for removing PVP from water and also creates a use for an otherwise waste product.

In some embodiments the first aqueous stream containing PVP can be from industrial water sources. However, it will be understood that the first aqueous stream containing PVP can be any aqueous liquid feed that contains undesirable amounts of PVP. Examples of such aqueous feeds include, among others, wastewater, groundwater or runoff, tap water, well water, rainwater, surface waters, such as water from lakes, ponds and wetlands, agricultural waters, and geothermal fluids.

In some embodiments, the second aqueous feed containing contaminants is groundwater or runoff However, it will be understood that the second aqueous feed can be any aqueous feed that contains undesirable amounts of contaminants. Examples of such aqueous feeds include, among others, tap water, well water, rainwater, surface waters, such as water from lakes, ponds and wetlands, agricultural waters, wastewater from industrial processes, runoff, and geothermal fluids.

### EXAMPLES

The following Examples are provided to illustrate the inventive PVP composition and methods in more detail, although the scope of the invention is never limited thereby in any way.

In all examples, Chemical Oxygen Demand (COD) was measured by Hach Method 8000 and P was measured by Hach Method 8048.

### Example 1

A water solution of polyvinylpyrrolidone with average molecular weight 40,000 was prepared by dissolving 20 g of this PVP into distilled water and diluting to 1 liter to create a solution with an effective 20 g/L PVP concentration. 400 ml of this solution was placed in a 500 ml steel beaker and stirred with a magnetic stirbar. The pH was raised to ˜12 by adding 10 M NaOH solution. The solution was then heated to 90° C. for 9 hours. The volume was maintained by addition of distilled water. The solution was then cooled to room temperature and pH adjusted to between 6 and 7.5 with 1 N HCl. Cerium chloride (CeCl₃) solution (2.6 mol/L Ce) was then slowly added. A total of 3 ml was added. After stirring for at least 30 minutes, a white precipitate formed. Samples were taken of the beginning solution and the final solution. The samples were filtered through a 0.45-micron filter and analyzed for COD (chemical oxygen demand). The starting solution had a COD of 31,500 mg/L, while the final solution had a COD of 21,000 mg/L which is a 33% reduction. The COD is a measure of the amount of PVP in the solution, so a 33% reduction in COD would indicated that 33% of the PVP has been removed from the solution.

### Example 2

400 ml of the remaining starting PVP solution from Example 1 was placed in a 500 ml steel beaker and stirred with a magnetic stirbar. The pH was raised to 13 by adding 10 M NaOH solution. The solution was then heated to 90° C. for 9 hours. The volume was maintained by addition of distilled water. A jelly like substance formed similar to what is reported in the literature (Conix, A. and G. Smets, “Ring Opening in Lactam Polymers”, J. Polymer Sci., 1955, Vol. XV, p 221-229). The solution was then cooled to room temperature and pH adjusted to between 6 and 7.5 with 1 N HCl. A sample was taken and filtered through a 0.45-micron filter and found to have a COD of 7400 mg/L, which is an effective 76.5% removal by the hydrolysis. A total of 3 ml of cerium chloride (CeCl₃) solution (2.6 mol/L Ce) was then added. After stirring for at least 30 minutes, a white precipitate formed. A sample was filtered through a 0.45-micron filter and found to have a COD of 800 mg/L, which is an effective 97.5% removal. The COD is a measure of the amount of PVP in the solution, so a 76.5% reduction in COD would indicated that 76.5% of the PVP was removed by the hydrolysis and that removal % was raised to 97.5% by the further addition of CeCl₃.

The remaining mixture was then filtered with a 50-micron porosity filter and washed with water. A sample of the solid was dried in a 105° C. oven for 48 hours and found to be 92.7% moisture. This dry solid was then burned, and the remaining ash was CeO₂ which accounted for 58.2% of the dry solid and 4.26% of the wet solid.

### Example 3

A water solution of polyvinylpyrrolidone with average molecular weight 1,300,000 was prepared by dissolving 15 g of this PVP into 15 L of tap water to create a solution with an effective 1.5 g/L PVP concentration. 1000 ml of this solution was placed in a 1000 ml glass beaker and stirred with a magnetic stirbar. The solution pH was then raised to 11-12 by adding 10 M NaOH (approximately 1 ml). The solution was then heated to ˜90° C. for 3 hours. After cooling the pH is adjusted to between 6 and 7.5 with 1 N HCl. A sample of the initial solution was analyzed and found to have 1,820 mg/L COD. Four aliquots of 20 ml each were taken. One was filtered through a 0.45-micron filter, and analyzed for COD. The COD was found to be 1,860 mg/L, which is 0% removal by the hydrolysis. The difference between 1,860 and 1,820 mg/L is zero because the measurements are within the error of analysis method.

### Example 3, Part A

To one of the aliquots, 50 μl of a 2.6 mol/L CeCl₃ solution was added. A white precipitate formed. A sample was filtered through a 0.45-micron filter and analyzed for COD. The COD was found to be 1,460 mg/L, which is a 19.8% reduction.

### Example 3, Part B

Iron chloride (FeCl₃) solution (40% FeCl₃) was added to the second 20 ml aliquot. A total of 50 μl was added. A reddish precipitate formed. A sample was filtered through a 0.45-micron filter and analyzed for COD. The COD was found to be 1,600 mg/L, which is a 12% reduction.

### Example 3, Part C

A solution was made by combining 0.5 ml 2.6 mol/L CeCl₃ and 0.5 ml of a 40% FeCl₃. To one of the aliquots, 50 μl of this solution was added. A reddish precipitate formed. A sample was filtered through a 0.45-micron filter and analyzed for COD. The COD was found to be 1,400 mg/L, which is a 23% reduction.

### Example 4

A water solution of polyvinylpyrrolidone with average molecular weight 40,000 was prepared by dissolving 20 g of this PVP into distilled water and diluting to 1 liter to create a solution with an effective 20 g/L PVP concentration. A sample of this solution was analyzed and found to have a COD of 43,320 mg/L. 400 ml of this solution was placed in a 500 ml round bottom flask equipped with a condenser and stirred with a magnetic stirbar. Ozone was then bubbled through the solution for 5 hours using an ozone generator that generates 1000 mg/hour for a total of 5000 mg. The solution pH was then raised to 13 by adding 10 M NaOH. The solution was then heated to 90° C. for 3 hours. After cooling the pH was adjusted to between 6 and 7.5 with 1 N HCl. The solution was then split into equal ˜100 ml portions. A sample is also taken, filtered through a 0.45-micron filter, and analyzed for COD. The COD was found to be 33,520 mg/L, which is a 22.6% reduction.

### Example 4, Part A

To one of the 100 ml portions, was added 1 ml of a 2.6 mol/L CeCl₃ solution. After stirring for at least 30 minutes, a white precipitate formed. A sample was taken, filtered through a 0.45-micron filter, and analyzed for COD. The COD was found to be 26,800 mg/L, which is a 38.1% reduction.

### Example 4, Part B

Iron chloride (FeCl₃) solution (40% FeCl₃) was added to the second portion 100 ml portion. A total of 1 ml was added. After stirring for at least 30 minutes, a reddish precipitate formed. A sample was taken, filtered through a 0.45-micron filter, and analyzed for COD. The COD was found to be 26,120 mg/L, which is a 39.7% reduction.

### Example 4, Part C

To one of the 100 ml portions, was added a mixture of 0.5 ml of a 2.6 mol/L CeCl₃ solution and 0.5 ml of a 40% FeCl₃ solution. After stirring for at least 30 minutes, a reddish precipitate formed. A sample was taken, filtered through a 0.45-micron filter, and analyzed for COD. The COD was found to be 25,680 mg/L, which is a 40.7% reduction.

### Example 5

A water solution of polyvinylpyrrolidone with average molecular weight 40,000 was prepared by dissolving 20 g of this PVP into distilled water and diluting to 1 liter to create a solution with an effective 20 g/L PVP concentration. The COD was measured to be 37,440 mg/L. 400 ml of this solution was placed in a 500 ml round bottom flask equipped with a condenser and stirred with a magnetic stirbar. Hydrogen peroxide (H₂O₂) 10 ml at 30% concentration was added. The solution pH was then raised to 13 by adding 10 M NaOH. The solution was then heated to 90° C. for 6 hours. After cooling the pH was adjusted to between 6 and 7.5 with 1 N HC1. The solution was then split into equal ˜100 ml portions. A sample was also taken, filtered through a 0.45-micron filter, and analyzed for COD. The COD is found to be 35,400 mg/L which is a 0.4% reduction.

### Example 5, Part A

To one of the 100 ml portions, was added 1 ml of a 2.6 mol/L CeCl₃ solution. After stirring for at least 30 minutes, a white precipitate formed. A sample was taken, filtered through a 0.45-micron filter, and analyzed for COD. The COD was found to be 35,200 mg/L, which is a 1.0% reduction.

### Example 5, Part B

Iron chloride (FeCl₃) solution (40% FeCl₃) was added to the second portion 100 ml portion. A total of 1 ml was added. After stirring for at least 30 minutes, a reddish precipitate formed. A sample was taken, filtered through a 0.45-micron filter, and analyzed for COD. The COD was found to be 32,400 mg/L, which is an 8.9% reduction.

### Example 5, Part C

To one of the 100 ml portions, was added a mixture of 0.5 ml of a 2.6 mol/L CeCl₃ solution and 0.5 ml of a 40% FeCl₃ solution. After stirring for at least 30 minutes, a reddish precipitate formed. A sample is taken, filtered through a 0.45-micron filter, and analyzed for COD. The COD was found to be 29,000 mg/L, which is an 18.4% reduction.

### Example 6

A water solution of polyvinylpyrrolidone with average molecular weight 1,300,000 was prepared by dissolving 20 g of this PVP into distilled water and diluting to 1 liter to create a solution with an effective 20 g/L PVP concentration. A sample was analyzed, and the COD was found to be 45,960 mg/L. 400 ml of this solution was placed in a 500 ml round bottom flask equipped with a condenser and stirred with a magnetic stirbar. The solution pH was then raised to 13 by adding 10 M NaOH. The solution was then heated to 90° C. for 6 hours. After cooling the pH was adjusted to between 6 and 7.5 with 1 N HCl. The solution was then split into equal ˜100 ml portions. A sample was also taken, filtered through a 0.45-micron filter, and analyzed for COD. The COD was found to be 43,240 mg/L, which is a 5.9% reduction.

### Example 6, Part A

To one of the 100 ml portions, was added 1 ml of a 2.6 mol/L CeCl₃ solution. After stirring for at least 30 minutes, a white precipitate forms. A sample was taken, filtered through a 0.45-micron filter, and analyzed for COD. The COD was found to be 2,120 mg/L, which is a 95.4% reduction.

### Example 6, Part B

Iron chloride (FeCl₃) solution (40% FeCl₃) was added to the second portion 100 ml portion. A total of 1 ml was added. After stirring for at least 30 minutes, a reddish precipitate formed. A sample was taken, filtered through a 0.45-micron filter, and analyzed for COD. The COD was found to be 1,810 mg/L, which is a 96.1% reduction.

### Example 6, Part C

To one of the 100 ml portions, was added a mixture of 0.5 ml of a 2.6 mol/L CeCl₃ solution and 0.5 ml of a 40% FeCl₃ solution. After stirring for at least 30 minutes, a reddish precipitate formed. A sample was taken, filtered through a 0.45-micron filter, and analyzed for COD. The COD was found to be 1,310 mg/L, which is a 97.1% reduction.

### Example 7

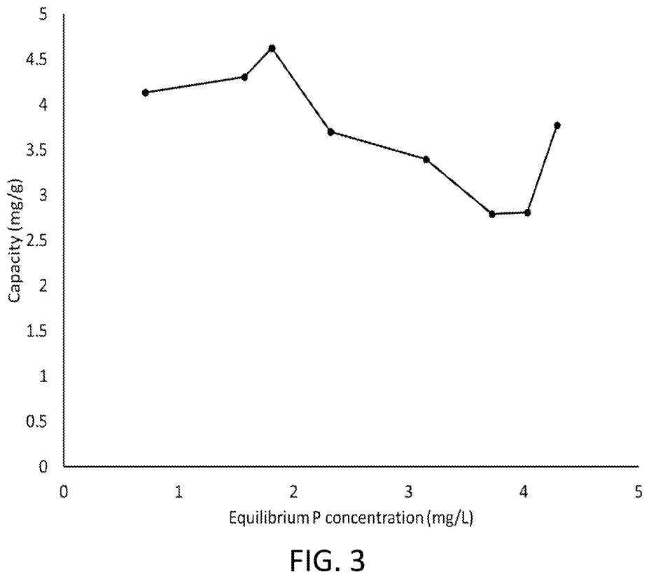

To test the phosphorus removal capacity of the composition of the precipitate from Example 2, the following experiment was done. Five liters each of 2 solutions were prepared using DI water and sodium phosphate monobasic with target concentrations of 3 and 5 mg/L P. Each solution was divided into five 1 L containers. To 4 of these containers ˜100, 200, 300, and 400 mg of the precipitate from Example 2 was added. The fifth container was left as a control. The containers were then placed into a tumbler and tumbled for 24 hours. The samples of the solutions were then filtered through a 0.45-micron syringe filter, analyzed for P using Hach method 10080, and reported in units of mg/L P. The difference between the control and the test solution was calculated as the amount of P bound to the solid. This number multiplied by the solution volume and divided by the solid weight was the calculated capacity given in mg/g. Results for each material are in the table below. The results are also plotted in FIG. 3 with the final P concentration in mg/L P plotted on the horizontal axis and the capacity in mg of P per gram of solid plotted on the vertical axis. The results are plotted in this way because it graphically depicts the distribution of the contaminant (P) between the amount adsorbed on the solid and the amount remaining in solution at equilibrium. Materials that adsorb better will, not only have a higher capacity, but will have a large slope at lower concentrations and have a slope that approaches zero at the concentration where the maximum capacity is reached.

TABLE 1
Capacity measurement of the solids from Example 2.

| Mass of | Initial P conc. | Final P conc. | Capacity |
|---|---|---|---|
| solid (g) | (mg/L) | (mg/L) | (mg/g) |
| 0.224 | 4.66 | 4.03 | 2.81 |
| 0.335 | 4.66 | 3.73 | 2.79 |
| 0.098 | 4.66 | 4.29 | 3.77 |
| 0.444 | 4.66 | 3.15 | 3.40 |
| 0.131 | 2.81 | 2.32 | 3.70 |
| 0.287 | 2.81 | 1.57 | 4.30 |
| 0.215 | 2.81 | 1.81 | 4.63 |
| 0.507 | 2.81 | 0.71 | 4.13 |

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. A method for removing polyvinylpyrrolidone (PVP) from an aqueous stream, comprising:
(i) providing an aqueous stream having a first PVP concentration;
(ii) hydrolyzing the aqueous stream to provide an aqueous stream containing hydrolyzed PVP (h-PVP);
(iii) contacting the aqueous stream containing h-PVP with a rare earth salt to precipitate h-PVP with rare earth cations bound to the h-PVP; and
(iv) providing a treated aqueous stream with a PVP concentration less than the first PVP concentration.

2. The method of claim 1, further comprising a step of filtering the treated aqueous stream to remove the precipitated h-PVP with rare earth cations bound to the h-PVP.

3. The method of claim 1, further comprising a step of decanting the treated aqueous stream to remove the precipitated h-PVP with rare earth cations bound to the PVP.

4. The method of claim 1, wherein the hydrolyzing of the aqueous stream comprises: adding a base to pH adjust to about 10 to about 14; heating to about 35° C. to about 140° C. for about 1 hr to about 10 hr; cooling to about 20° C. to about 25° C.; and optionally adding an acid to pH adjust to about 6 to less than about 8.

5. The method of claim 4, wherein the hydrolyzing of the aqueous stream further comprises oxidizing the aqueous stream before adding the base.

6. The method of claim 5, wherein the oxidizing includes adding hydrogen peroxide, ozone, or mixtures thereof.

7. The method of claim 1, wherein the rare earth salts are salts of rare earths selected from the group consisting of cerium, lanthanum, yttrium, and mixtures thereof.

8. The method of claim 7, wherein the rare earth salts are selected from the group consisting of chlorides, sulfates, sulfonates, nitrates, acetates, and mixtures thereof.

9. The method of claim 1, wherein the PVP concentration in the treated aqueous stream is about 50% to about 100% less than the first PVP concentration.

10. The method of claim 1, further comprising the steps of setting a target concentration for PVP in the treated aqueous stream and wherein the treated aqueous stream has a PVP concentration that is at or below the target concentration.

11. The method of claim 1, further comprising setting a target concentration for the PVP in the treated aqueous stream; monitoring the PVP concentration in the treated stream; and comparing it to the target concentration.

12. A composition for treating water comprising (a) hydrolyzed polyvinylpyrrolidone (h-PVP) and (b) rare earth cations, wherein the cations are bound to the h-PVP and wherein the composition comprises about 1% to about 50% by weight rare earth cations based on the total weight of the composition not taking into account any water present in the composition.

13. The composition of claim 12, wherein the h-PVP is about 20% to about 75% hydrolyzed.

14. The composition of claim 12, wherein the rare earth cations are cations selected from the group consisting of cerium, lanthanum, yttrium, and mixtures thereof.

15. The composition of claim 12, further comprising anions selected from the group consisting of chloride, nitrate, sulfate, sulfonate, acetate, and mixtures thereof

16. The composition of claim 15, wherein the composition comprises about 0.5% to about 10% by weight anions based on the total weight of the composition not taking into account any water present in the composition.

17. The composition of claim 12, wherein the rare earth cations are Ce, La, or a mixture of Ce and La.

18. The composition of claim 12, wherein the composition comprises about 10% to about 40% by rare earth cations based on the total weight of the composition not taking into account any water present in the composition.

19. A method for removing contaminants from an aqueous stream, comprising:
(i) contacting an aqueous stream having a first contaminant concentration with a composition for treating water comprising (a) hydrolyzed polyvinylpyrrolidone (h-PVP) and (b) rare earth cations, wherein the cations are bound to the h-PVP and wherein the composition comprises about 1% to about 50% by weight rare earth cations based on the total weight of the composition not taking into account any water present in the composition;
(ii) removing contaminant from the aqueous stream by contact of the aqueous stream with the composition; and
(iii) providing a treated aqueous stream with a second contaminant concentration less than the first contaminant concentration,
wherein the contaminant is selected from the group consisting of phosphate, phosphorus containing compounds, arsenic, arsenic containing compounds, PFAS, fluorides, and mixtures thereof.

20. The method of claim 19, wherein the composition comprises about 10% to about 40% by weight rare earth cations based on the total weight of the composition not taking into account any water present in the composition.

21. The method of claim 19, wherein the rare earth cations are Ce, La, or a mixture of Ce and La.

22. The method of claim 19, wherein the aqueous stream is rainwater or water run-off.

23. The method of claim 19, wherein the second contaminant concentration is about 50% to about 90% less than the first contaminant concentration.

24. The method of claim 19, further comprising the steps of setting a target concentration for the contaminant in the treated aqueous stream and wherein the second contaminant concentration is at or below the target concentration.

25. The method of claim 19, further comprising setting a target concentration for the contaminant in the treated aqueous stream; monitoring the second contaminant concentration and comparing it to the target concentration; and replacing the composition when the second contaminant concentration in the treated aqueous stream exceeds the target concentration.

26. An integrated method for removing polyvinylpyrrolidone (PVP) from an industrial aqueous stream and recycling the removed PVP composition to remove contaminants from wastewater comprising the steps of:
(i) providing an industrial aqueous stream having a first PVP concentration;
(ii) hydrolyzing the industrial aqueous stream to provide an aqueous stream containing hydrolyzed PVP (h-PVP);
(iii) contacting the aqueous stream containing h-PVP with a rare earth salt to precipitate h-PVP with rare earth cations bound to the h-PVP; and
(iv) isolating the precipitated h-PVP with rare earth cations bound to the h-PVP;
(v) contacting a wastewater stream having a first contaminant concentration with the precipitated h-PVP with rare earth cations bound to the h-PVP and removing contaminants from the wastewater stream; and
(vi) providing a treated stream with a second contaminant concentration less than the first contaminant concentration,
wherein the contaminant is selected from the group consisting of phosphate, phosphorus containing compounds, arsenic, arsenic containing compounds, PFAS, fluorides, and mixtures thereof.
